(19) United States
(12) Patent Application Publication
(10) Pub. No.: US 2008/0129438 A1
(43) Pub. Date: Jun. 5, 2008

(54) NOISE FILTER AND MANUFACTURING METHOD THEREOF

(76) Inventors: Cheng-Hong LEE, Taoyunan Hsien (TW); Yu- Lin HSUEH, Taoyuan Hsien (TW); Yi-Hong HUANG, Taoyuan Hsien (TW); Chuan-Yuan KUNG, Taoyuan (TW); Chih-Wei KUO, Taoyuan Hsien (TW)

Correspondence Address: BIRCH STEWART KOLASCH & BIRCH, PO BOX 747, FALLS CHURCH, VA, 22040-0747, US

(21) Appl. No.: 11/935,499

(22) Filed: Nov. 6, 2007

(30) Foreign Application Priority Data
Dec. 1, 2006 (TW) 095144572

(51) Int. Cl. H01F 27/33; H01F 41/08

(52) U.S. Cl. 336/220; 29/605

(57) ABSTRACT

A noise filter includes a magnetic conduction housing and a pair of coils. The magnetic conduction housing has a main body and a magnetic conduction position. The main body is hollow. The magnetic conduction position is connected with the main body to divide the main body into two parts. The coils are wound around the main body. In addition, the manufacturing method of the noise filter is also provided.

### CROSS REFERENCE TO RELATED APPLICATIONS

This Non-provisional application claims priority under 35 U.S.C. §119(a) on Patent Application No(s).095144572, filed in Taiwan, Republic of China on Dec. 1, 2006, the entire contents of which are hereby incorporated by reference.

### BACKGROUND OF THE INVENTION

1. Field of Invention

The present invention relates to a noise filter and, in particular to a noise filter with good filtering properties and low cost.

2. Related Art

Electronic products such as power supplies and electrical power converters often operate at high frequencies, and electromagnetic interferences (EMI) generated during the operation of such electronic products will affect the operation thereof. According to different transmission ways, EMIs can be divided into radiative and transmissive types. The radiative EMI is transmitted directly via the open space. The transmissive EMI is transmitted via wires.

The transmissive EMI further includes common-mode noises and differential-mode noises. They differ in the propagating path of the noise current. The differential-mode noise occurs when the currents of two wires are in opposite directions. The common-mode noise occurs when they are in the same direction. Generally speaking, using an EMI filter circuit is the first step to avoid electromagnetic radiation. It mainly includes a choke coil arid a capacitor for suppressing the production or penetration of noises.

Please refer to FIG. 1A and FIG. 1B. A conventional choke coil 1 is used to eliminate common-mode and differential-mode noises. It includes a large ring iron core 10, a small ring iron core 11, and a pair of coils 12. The small ring iron core 11 has a ring body 111 and a magnetic conduction portion 112 disposed in the ring body 111. The small ring iron core 11 is disposed in a space formed by the large ring iron core 10, and the large ring iron core 10 and the small ring iron core 1 are separated by a spacer 13. The coils 12 are wound around the large ring iron core 10 and the small ring iron core 11.

The large ring iron core 10 is made by magnetic ferrites or amorphous materials, for eliminating common-mode noises. The small ring iron core 11 is made by a dust core of low magnetic conductivity for eliminating differential-mode noises. As shown in FIG. 1A, when the currents I₁, and I₂ flow through the coils 12 in the directions indicated by the arrows, magnetic fluxes φ₁ and φ₂ are generated at the large ring iron core 10. Such fluxes circulate in a close magnetic path and attenuate as they are converted into heat energy through eddy currents. Therefore, the common-mode noises are worn away.

As shown in FIG. 1B, when the current 13 flows through the coils 12 in the direction indicated by the arrow, magnetic fluxes φ₃ and φ₄ are produced in the small ring iron core 11. The magnetic fluxes circulate in the left and right halves of the ring body 111 of the small ring iron core 1l. They are converted into heat energy through eddy currents in the closed magnetic path. This removes the differential-mode noises.

However, the configuration of two independent cores requires a large area for the entire choke structure, which is not suitable for miniaturization and lowering the cost. Moreover, the cores are likely to produce eddy currents to influence surrounding elements, and the core itself is sensitive to its surrounding magnetic field as well. All such factors make the properties of the entire choke structure unstable.

### SUMMARY OF THE INVENTION

In view of the foregoing, the present invention is to provide a noise filter and the manufacturing method thereof, which have better performance and lower cost.

To achieve the above, the present invention discloses a noise filter including a magnetic conduction housing and a pair of coils. The magnetic conduction housing has a hollow main body and a magnetic conduction portion connected with the main body to divide the main body into two parts. The coils are wound around said two parts of the main body, respectively.

To achieve the above, the present invention also discloses a manufacturing method for the noise filter. The manufacturing method includes the steps of providing a magnetic conduction housing, which has a hollow main body and a magnetic conduction portion, and winding a pair of coils around the main body. The magnetic conduction portion is connected with the main body to divide it into two parts.

As mentioned above, a pair of coils is wound around a magnetic conduction housing to form a noise filter. This replaces the core for making a noise filter in the prior art. Since the magnetic conduction housing requires less material in, for example, injection molding than the solid core. Therefore, the production cost can be reduced. At the same time, the present invention still has good filtering properties of the core in the prior art.

### BRIEF DESCRIPTION OF THE DRAWINGS

The present invention will become more fully understood from the detailed description given herein below illustration only, and thus is not limitative of the present invention, and wherein:

FIG. 1A is a schematic view showing how the common-mode noises are removed by an inductor in the prior art;

FIG. 1B is a schematic view showing how the differential-mode noises are removed by the inductor in FIG. 1A;

FIG. 2 is a schematic view of a noise filter according to the preferred embodiment of the present invention;

FIG. 3 is a three-dimensional view of the magnetic conduction housing in the noise filter of FIG. 2;

FIG. 4 is a flowchart of the manufacturing method for a noise filter according to the preferred embodiment of the present invention; and

FIGS. 5 and 6 show the results of measured noises from the electronic device without and with the noise filter of the present invention.

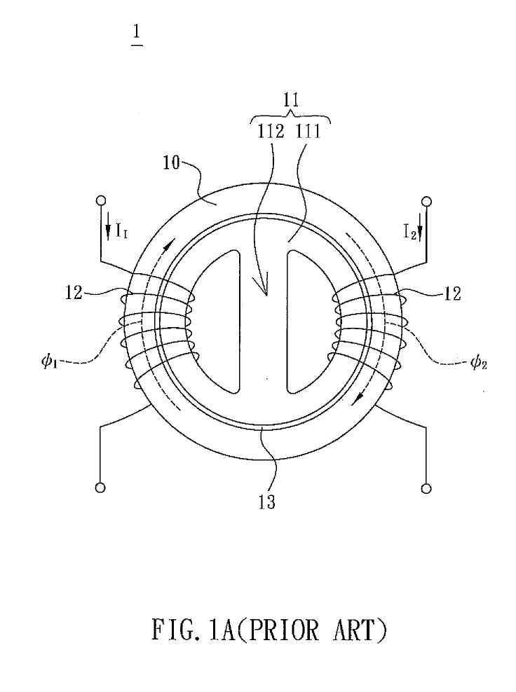

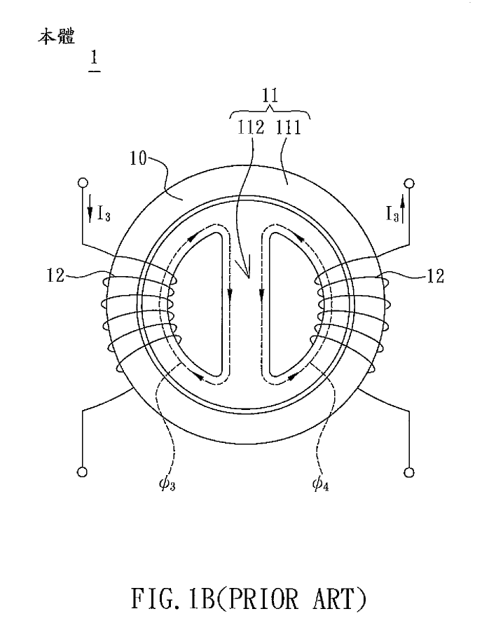

### DETAILED DESCRIPTION OF THE INVENTION

The present invention will be apparent from the following detailed description, which proceeds with reference to the accompanying drawings, wherein the same references relate to the same elements.

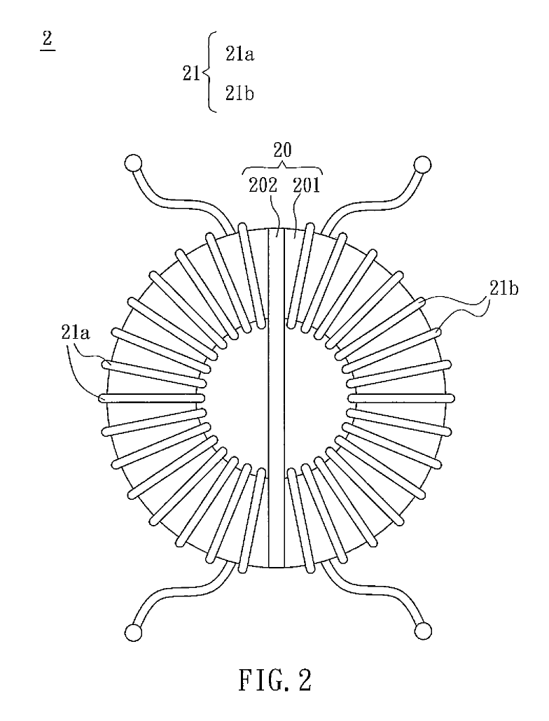

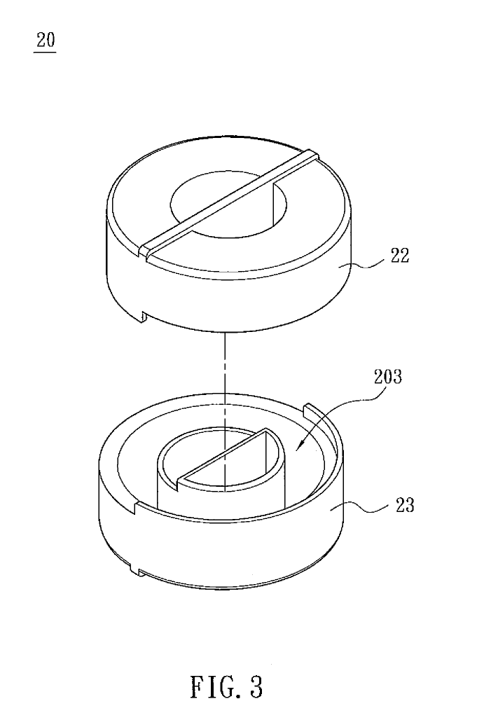

Please refer both to FIGS. 2 and 3. As shown in FIG. 2, a noise filter 2 according to the preferred embodiment of the present invention includes a magnetic conduction housing 20 and a pair of coils 21. The noise filter 2 in this embodiment is used in an electronic device that generates noises. In particular, the electronic device is a power supply.

The magnetic conduction housing 20 has a main body 201 and a magnetic conduction portion 202. The main body 201 is hollow. The magnetic conduction portion 202 is connected with the main body 201 to divide the main body 201 into two parts. In this embodiment, as shown in FIG. 3, the main body has a ring shape. The magnetic conduction portion 202 is like a bridge across the main body 201, but the shape of the main body 201 in this embodiment is only one example. Any shape that forms a closed path should be included in the present invention. For example, it can have a square ring shape or some irregular ring shape.

As shown in FIG. 2, the coils 21 are wound around the two parts of the main body 201 of the magnetic conduction housing 20, respectively. In this embodiment, one coil 21a is wound around the left half part of the magnetic conduction housing 20, and the other coil 21b is wound around the right half part of the magnetic conduction housing 20. The magnetic conduction housing 20 allows the currents flowing through the coils 21 to form a close magnetic path, thereby eliminating the differential-mode noises.

Moreover, the magnetic conduction housing 20 can be formed by two half housings. As shown in FIG. 3, the magnetic conduction housing 20 includes a first housing 22 and a second housing 23, both of which are connected together to form the magnetic conduction housing 20. However, the present invention is not limited to this example. The magnetic conduction housing can be integrally formed as a single component or can be constituted by more than two separate components. As shown in FIG. 3, the magnetic conduction housing 20 is a thin housing with a hollow space 203 formed inside of the magnetic conduction housing 20. Furthermore, there can be another core capable of eliminating the common-mode noises inserted into the hollow space 203 of the magnetic conduction housing 20 according to user's need for both eliminating the common-mode noises and differential-mode noises by one noise filter. In addition, the present invention also allows various thickness of the magnetic conduction housing 20.

The magnetic conduction housing 20 is formed from a mixture of at least one magnetic material sized in nanometer and a resin by injection molding, pressure molding, cast molding, or fill molding. The magnetic material can be a magnetic ferrite or magnetic powders. The ferrite can be Mn-Zn ferrite or Ni-Zn ferrite. The magnetic powders can be iron-contained magnetic powders, iron-alloy-contained magnetic powders, amorphous magnetic powders, or crystal magnetic powders. The iron-alloy-contained magnetic powders can be selected from Fe-Si alloy powders, Fe-Si-Al alloy powders, Fe-Ni alloy powders, Fe-Co alloy powders, Mo-Fe-Ni powders, and their combinations. Beside, the resin in this embodiment is a thermoplastic resin, a thermoset resin, or a photocuring resin. The thermoplastic resin is a thermoplastic PU (TPU).

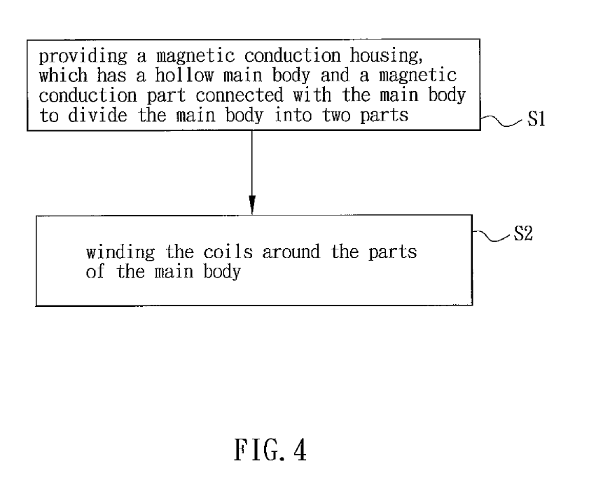

With reference to FIG. 4, the manufacturing method for the noise filter according to the preferred embodiment of the present invention includes steps S1 and S2.

In step S1, a magnetic conduction housing with a main body and a magnetic conduction portion is provided. The main body is hollow. The magnetic conduction portion is connected with the main body to divide the main body into two parts.

In this embodiment, the magnetic conduction housing is formed from a mixture of at least one magnetic material sized in nanometer and a resin by injection molding, pressure molding, cast molding, or fill molding. Since the structural features and the selection of magnetic material and resin are the same as in the previous embodiment, the description is not repeated herein. In this embodiment, the magnetic conduction housing is preferably formed from a mixture of 80% Mn-Zn ferrite in weight and the TPU.

In step S2, the coils are wound around the two parts of the main body, respectively. One coil is wound around the left half part of the magnetic conduction housing, and the other coil is wound around the right half part of the magnetic conduction housing. When a current flows through the magnetic conduction housing, a magnetic flux is produced in a closed magnetic path to remove the differential-mode noises.

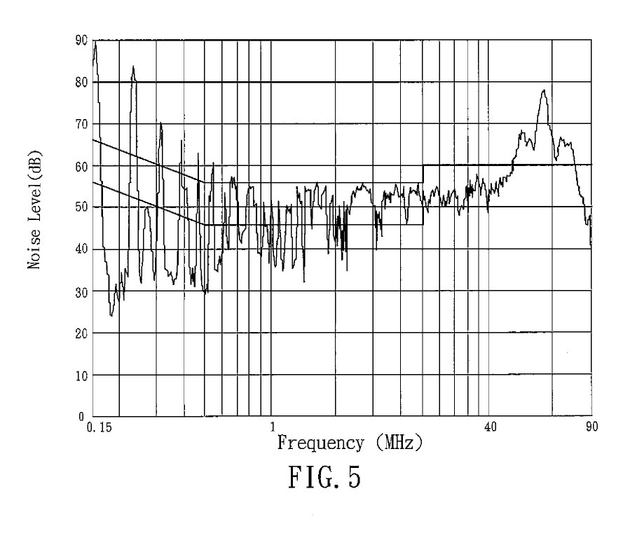

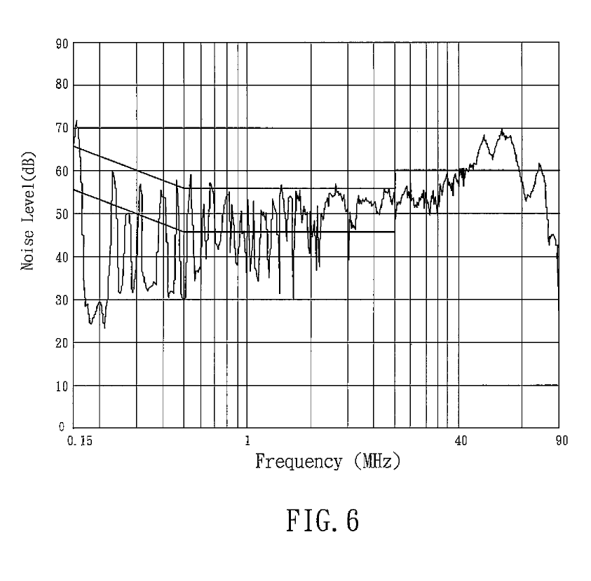

Please refer to FIGS. 5 and 6, which show the results of measured noises from the electronic device without and with the noise filter. As shown in FIG. 5, when the EMI filter module does not use the noise filter of present invention, there are serious EMI noises at low frequencies (150 kHz-300 kHz). There are also noise peaks at high frequencies. As shown in FIG. 6, on the other hand, the EMI noises at low frequencies are effectively suppressed after the disclosed noise filter of the present invention is used. More explicitly, using the disclosed noise filter of the present invention, the noise at 150 kHz is suppressed by 17 dB and the noise at 300 kHz is suppressed by 15 dB. Besides, the noises at high frequencies are also suppressed.

In summary, according to the present invention, a pair of coils is wound around a magnetic conduction housing to form a noise filter. This replaces the core for making a noise filter in the prior art. Since the magnetic conduction housing requires less material in, for example, injection molding than the solid core. Therefore, the production cost can be reduced. At the same time, the present invention still has good filtering properties of the core in the prior art.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A noise filter, comprising:
a magnetic conduction housing, which has a hollow main body and a magnetic conduction portion connected with the main body to divide the main body into two parts; and
a pair of coils, which are wound around said two parts of the main body, respectively.

2. The noise filter of claim 1, wherein the magnetic conduction housing comprises a first housing and a second housing, both of which are connected together to form the magnetic conduction housing.

3. The noise filter of claim 1, wherein the magnetic conduction housing comprises a resin and at least one magnetic material sized in nanometer.

4. The noise filter of claim 3, wherein the resin is a thermoplastic resin, a thermoset resin, or a photocuring resin.

5. The noise biter of claim 4, wherein the thermoplastic resin is thermoplastic PU (TPU).

6. The noise filter of claim 3, wherein the magnetic material is a magnetic ferrite or magnetic powders.

7. The noise filter of claim 6, wherein the magnetic ferrite is a Ma-Zn ferrite or a Ni-Zn ferrite and the magnetic powders are iron-contained magnetic powders, iron-alloy-contained magnetic powders, amorphous magnetic powders, or crystal magnetic powders.

8. The noise filter of claim 7, wherein the iron-alloy-contained magnetic powders are selected from the group consisting of Fe-Si alloy powders, Fe-Si-Al alloy powders, Fe-Ni alloy powders, Fe-Co alloy powders, Mo-Fe-Ni alloy powders, and their combinations.

9. The noise filter of claim 1, wherein the magnetic conduction housing is formed by injection molding, pressure molding, cast molding, or fill molding.

10. The noise filter of claim 1, wherein the main body has a ring shape.

11. The noise filter of claim 1, which is used in an electronic device, such as a power supply, that produces noises.

12. The noise filter of claim 1, wherein the main body is further disposed with a core capable of eliminating common-mode noises.

13. A manufacturing method for a noise filter, comprising steps of:
providing a magnetic conduction housing, which has a hollow main body and a magnetic conduction portion connected with the main body to divide the main body into two parts; and
winding a pair of coils around said two parts of the main body, respectively,

14. The manufacturing method of claim 13, wherein the magnetic conduction housing comprises a first housing and a second housing, and before the step of winding the coils, the manufacturing method further comprises a step of:
assembling and connecting the first housing and the second housing so as to form the magnetic conduction housing.

15. The manufacturing method of claim 14, wherein before the step of assembling and connecting the first housing and the second housing, the manufacturing method further comprises a step of:
disposing a core capable of eliminating common-mode noises into the main body.

16. The manufacturing method of claim 13, wherein the magnetic conduction housing comprises a resin and at least one magnetic material sized in nanometer.

17. The manufacturing method of claim 16, wherein the resin is a thermoplastic resin, a thermoset resin, or a photocuring resin, and the magnetic material is a magnetic ferrite or magnetic powders.

18. The manufacturing method of claim 17, wherein the magnetic ferrite is a Mn-Zn ferrite or a Ni-Zn ferrite, and the magnetic powders are iron-contained magnetic powders, iron-alloy-contained magnetic powders, amorphous magnetic powders, or crystal magnetic powders

19. The manufacturing method of claim 18, wherein the iron-alloy-contained magnetic powders are selected from the group consisting of Fe-Si alloy powders, Fe-Si-Al alloy powders, Fe-Ni alloy powders, Fe-Co alloy powders, Mo-Fe-Ni powders, and their combinations.

20. The manufacturing method of claim 13, wherein the magnetic conduction housing is formed by injection molding, pressure molding, cast molding, or fill molding.
